(19) United States
(12) Patent Application Publication
(10) Pub. No.: US 2007/0228229 A1
(43) Pub. Date: Oct. 4, 2007

(54) Column support member

(75) Inventor: Won Duk Han, Suzuku-shi (JP)

Correspondence Address: JACOBSON HOLMAN PLLC, 400 SEVENTH STREET N.W., SUITE 600, WASHINGTON, DC, 20004, US

(73) Assignee: RAIMU, INC., Suzuka-shi (JP)

(21) Appl. No.: 11/802,838

(22) Filed: May 25, 2007

Related U.S. Application Data
(62) Division of application No. 11/327,400, filed on Jan. 9, 2006.
Application No. 11/327,400 is a continuation of application No. PCT/JP03/08656, filed on Jul. 8, 2003.

(51) Int. Cl. F16L 3/00

(52) U.S. Cl. 248/121

(57) ABSTRACT

Disclosed is a pole support assembly, which comprises a weight member adapted to guide a part of an outer peripheral side surface of a pole, such as a tent, and a retaining member adapted to be fastened to the weight member so as to retain the pole relative to the weight member. The weight member has a first side surface extending vertically, a second side surface extending vertically and intersecting with the first side surface, a third side surface extending vertically and intersecting with the first and second side surfaces, and a guide recess extending vertically along an intersect line between the first and second side surfaces to guide the part of the outer peripheral side surface of the pole. Preferably, the first and second side surfaces are formed to intersect with one another at a right angle.

The present patent application is a division of application Ser. No. 11/327,400, filed Jan. 9, 2006, which is a continuation of PCT/JP2003/008656 filed Jul. 8, 2003 and published in Japanese, both of which are incorporated herein by reference in their entireties.

### BACKGROUND OF THE INVENTION

1. Field of the Invention

The present invention relates to a pole support assembly designed to support a plurality of poles for a structure having an upper structural member attached to the pole. In particular, the present invention relates to a pole support assembly capable of supporting a pole for a tent having an upper structural member, such as canopy, by use of a weight member and a retaining member.

2. Related Art

Heretofore, there has been known a pole stabilizer comprises a plurality of divided block members divided along a plane passing through a through-hole which is to be formed in such a manner as to allow a pole to penetrate vertically therethrough when they are joined together, and a gripping depression and grip portion formed in each of the block members, joint means for dividably joining the bock members together, and a container portion formed inside each of the block members (see, for example, the following Patent Publication 1).

There has also been known a pole anchor for a portable house, which has a hollow truncated-cone-shaped vertically-divided structure consisting of a pair of right and left bodies made of canvas or plastic. Each of the bodies has a water filling/discharge port formed in a top surface thereof and a waterproof bag housed therein (see, for example, the following Patent Publication 2).

Further, there has been known an anchor bag for anchoring a pneumatic structure, which comprises a plurality of internal spaces, at least two liquid filling/discharge ports, and at least two fixing devices adapted to be connected to the pneumatic structure (see, for example, the following Patent Publication 3).

As viewed from a structural standpoint, each of the above pole stabilizer, pole anchor and anchor bag inevitably protrudes from the entire circumference of a leg (pole) of a tent. This makes it difficult to attach a lower portion of a tent side curtain to the tent leg (pole). Specifically, a tent side curtain generally has a portion for allowing a fixing rope or string to be fastened thereto, at each of the uppermost corners and lowermost corners thereof whenever it is formed therein. Therefore, when using the conventional pole support, such as the pole stabilizer, a lower portion of the side curtain cannot be attached to a tent pole using the string fastened to the lowermost corner of the side curtain. That is, when using the conventional pole support, such as the pole stabilizer, while the side curtain can be attached to a portion of the pole having no contact with the pole stabilizer, the lower portion of the side curtain cannot be attached to the pole to cause a problem about poor appearance and flapping occurring when the wind blows.

Moreover, each of the above pole stabilizer, pole anchor and anchor bag has a circular shape in horizontal section which is likely to produce a dead space in a stored state.

Each of the above pole stabilizer, pole anchor and anchor bag involves another problem about difficulty in transportation.

Each of the above pole stabilizer, pole anchor and anchor bag involves yet another problem about difficulty in preventing lateral wobbling of a tent.

[Patent Publication 1]

Japanese Patent Publication No. 08-006509 (see pages 3 to 5, FIGS. 1 to 4)

[Patent Publication 2]

Japanese Utility Model Laid-Open Publication No. 63-054744 (see page 1, FIGS. 1 and 2)

[Patent Publication 3]

Japanese Patent Laid-Open Publication No. 2000-064668 (see pages 2 and 3)

### SUMMARY OF THE INVENTION

In view of the above circumstances, it is therefore an object of the present invention to provide a tent pole support assembly having a shape allowing storage in a stacked manner.

It is another object of the present invention to provide a tent pole support assembly capable of allowing a side curtain to be attached thereto in a state after supporting a tent pole.

It is yet another object of the present invention to provide a tent pole support assembly capable of maintaining a silhouette of a side curtain attached thereto, substantially horizontally.

It is still another object of the present invention to provide a tent pole support assembly having a shape capable of minimizing redundant storage space.

It is yet still another object of the present invention to provide a tent pole support assembly capable of facilitating transportation.

It is another further object of the present invention to provide a tent pole support assembly capable of preventing wobbling of a tent.

It is still a further object of the present invention to provide a tent pole support assembly usable as an advertising medium.

It is an additional object of the present invention to provide a tent pole support assembly capable of being turned over 180-degree relative to a tent pole horizontally from a normal position so as to be set up at a second position allowing an internal area of a tent to have a utilization rate close to 100%.

In order to achieve the above object, according to a first aspect of the present invention, there is provided a pole support assembly designed to support a pole for a given structure, which comprises a weight member adapted to guide a part of an outer peripheral side surface of the pole, and a retaining member adapted to be fastened to the weight member so as to retain the pole relative to the weight member, wherein the weight member has a first side surface extending vertically, a second side surface extending vertically and intersecting with the first side surface, and a guide recess extending vertically along an intersect line between the first and second side surfaces to guide the part of the outer peripheral side surface of the pole.

The above pole support assembly of the present invention makes it possible to allow a side curtain for the structure to be attached thereto in a state after supporting the pole, while maintaining a silhouette of the side curtain attached thereto, substantially horizontally.

In the pole support assembly of the present invention, it is preferable that the first and second side surfaces of the weight member are formed to intersect with one another at a right angle. This allows a plural number of the pole support assemblies to be stored in a stacked manner so as to effectively utilize a storage space.

According to a second aspect of the present invention, there is provided a pole support assembly designed to support a pole for a given structure, which comprises a weight member adapted to guide a part of an outer peripheral side surface of the pole, and a retaining member adapted to be fastened to the weight member so as to retain the pole relative to the weight member, wherein the weight member has a first side surface extending vertically, a second side surface extending vertically and parallel to or at an angle of 90-degree or less relative to the first side surface, a connection portion connecting between the first and second surfaces, and a guide recess formed in the connection portion to extend vertically so as to guide the part of the outer peripheral side surface of the pole. This pole support assembly of the present invention makes it possible to allow a side curtain for the structure to be attached thereto in a state after supporting the pole, while maintaining a silhouette of the side curtain attached thereto, substantially horizontally.

According to a third aspect of the present invention, there is provided a pole support assembly designed to support a pole for a given structure, which comprises a weight member adapted to guide a part of an outer peripheral side surface of the pole, and a retaining member adapted to be fastened to the weight member so as to retain the pole relative to the weight member, wherein the weight member has an outer peripheral side surface at least partially extending vertically, and a guide recess formed to continue from the vertically-extending outer peripheral side surface and extend vertically so as to guide the part of the outer peripheral side surface of the pole. This pole support assembly of the present invention makes it possible to allow a side curtain for the structure to be attached thereto in a state after supporting the pole, while maintaining a silhouette of the side curtain attached thereto, substantially horizontally.

In the pole support assembly set forth in either one of the first to third aspect of the present invention, it is preferable that the weight member includes a container segment for containing a liquid substance and/or a solid substance. In this case, only during use, the liquid substance and/or the solid substance can be contained in the pole support assembly to increase a weight of the pole support assembly.

More preferably, the weight member is designed to allow the in container segment to be detachably attached thereto in a telescoping manner. In this case, the container segment can be detached from the weight member to facilitate filling the container segment with water or the like. In addition, the container segment can be detached from the weight member to make it easy to transport the container segment.

In the pole support assembly set forth in either one of the first to third aspect of the present invention, it is preferable that the weight member is formed with a receiving portion for receiving therein a part of the retaining member to allow the retaining member to be fastened to the weight member.

In the pole support assembly set forth in either one of the first to third aspect of the present invention, it is preferable that the weight member is formed with an arm-mounting portion adapted to allow a connection arm for connecting a plural number of the weight members together to be mounted thereto. In this case, the connection arm can be effectively used for preventing a lateral wobbling of the structure, such as a tent.

In the pole support assembly set forth in either one of the first to third aspect of the present invention, it is preferable that the retaining member includes a first lock member having one end adapted to be fastened to the weight member, and a second lock member having one end adapted to be fastened to the weight member, wherein the first lock member is designed to be locked relative to the second lock member so as to retain the pole relative to the weight member. In this case, an operation for attaching or detaching the pole support assembly to or from the pole can be readily performed without using a particular tool.

In the pole support assembly set forth in either one of the first to third aspect of the present invention, it is preferable that the weight member is provided with a wheel for moving the weight member. In this case, the weight member can be readily transported.

In the pole support assembly set forth in either one of the first to third aspect of the present invention, it is preferable that the weight member is formed with one or more fastening holes each adapted to allow a string of a side curtain for the structure to be fastened thereto. In this case, a string located at a lower portion of the side curtain can be fastened to the pole support assembly to provide excellent appearance and eliminate the risk of occurrence of flapping of the side curtain due to wind.

In the pole support assembly set forth in the first aspect of the present invention, it is preferable that the guide recess of the weight member serves as a first pole-guide portion extending vertically to guide a part of an outer peripheral side surface of a first pole, wherein the weight member further has a second pole-guide portion for partly holding respective outer peripheral side surfaces of second and third poles in adjacent relation to one another. In this case, two poles can be simultaneously supported while supporting another pole only by preparing one type of weight member.

### BRIEF DESCRIPTION OF DRAWINGS

FIG. 1 is a perspective view showing a pole support assembly according to a first embodiment of the present invention, in a state after the pole support assembly supports a pole.

FIG. 2 is a perspective view showing a weight member of the pole support assembly according to the first embodiment.

FIG. 3 is a perspective view showing a retaining member of the pole support assembly according to the first embodiment.

FIG. 4 is a perspective view showing one example of a usage mode of the pole support assembly according to the first embodiment, wherein each pole is supported by the pole support assembly, and a side curtain unit is mounted between two of the poles.

FIG. 5 is a front view showing one example of the usage mode of the pole support assembly according to the first embodiment, wherein two of the pole support assemblies are connected to one another by a connection arm.

FIG. 6 is a top view showing one example of modification of the pole support assembly according to the first embodiment, wherein the pole support assembly is designed to support a pole having a square shape in section.

FIG. 7 is a top view showing another example of modification of the pole support assembly according to the first embodiment, wherein the pole support assembly is designed to support a relatively thick pole having a square shape in section.

FIG. 8 is a top view showing yet another example of modification of the pole support assembly according to the first embodiment, wherein the pole support assembly is designed to support a relatively thin pole having a square shape in section.

FIG. 9 is a top view showing still another example of modification of the pole support assembly according to the first embodiment, wherein the pole support assembly is designed to support a pole having a circular shape in section.

FIG. 10 is a top view showing yet still another example of modification of the pole support assembly according to the first embodiment, wherein the pole support assembly is designed to have a quadrangular shape in section and support a pole having a square shape in section.

FIG. 11 is a top view showing another further example of modification of the pole support assembly according to the first embodiment, wherein the pole support assembly is designed to have an obtuse-triangular shape in section and support a pole having a circular shape in section.

FIG. 12 is a top view showing still a further example of modification of the pole support assembly according to the first embodiment, wherein the pole support assembly is designed to have an acute-triangular shape in section and support a pole having a circular shape in section.

FIG. 13 is a top view showing an additional example of modification of the pole support assembly according to the first embodiment, wherein the pole support assembly is designed to have an oblong shape in section and support a pole having a square shape in section.

FIG. 14 is a top view showing another example of the usage mode of the pole support assembly according to the first embodiment, wherein two of the pole support assemblies are connected to one another by a connection arm.

FIG. 15 is a perspective view showing a pole support assembly comprising a weight member and a lock member, according to a second embodiment of the present invention.

FIG. 16 a top view showing the pole support assembly according to the second embodiment, during an operation for supporting a pole using the weight member and the lock member,

FIG. 17 is a perspective view showing a pole support assembly according to a third embodiment of the present invention, in a state after the pole support assembly supports a pole.

FIG. 18 is a perspective view showing the pole support assembly according to the third embodiment of the present invention, in a state after the pole support assembly supports a pole using a weight member and a lock member thereof.

FIG. 19 is a side view showing a pole support assembly comprising a weight member and a lock member, according to a fourth embodiment of the present invention.

FIG. 20 is a top view showing a weight member in a pole support assembly according to a fifth embodiment of the present invention.

FIG. 21 is a top view showing one example of a usage mode of the pole support assembly according to the fifth embodiment, wherein each pole is supported by the support assembly set up at a normal position.

FIG. 22 is a top view showing another example of the usage mode of a pole support assembly according to one embodiment of the present invention, wherein each pole is supported by the support assembly turned over 180-degree relative to a pole horizontally from a normal position.

### DETAILED DESCRIPTION OF THE PREFERRED EMBODIMENTS

With reference to the drawings, various embodiments of the present invention will now be described.

### [1] First Embodiment

A pole support assembly according to a first embodiment of the present invention will be firstly described below.

Structure of Pole Support Assembly

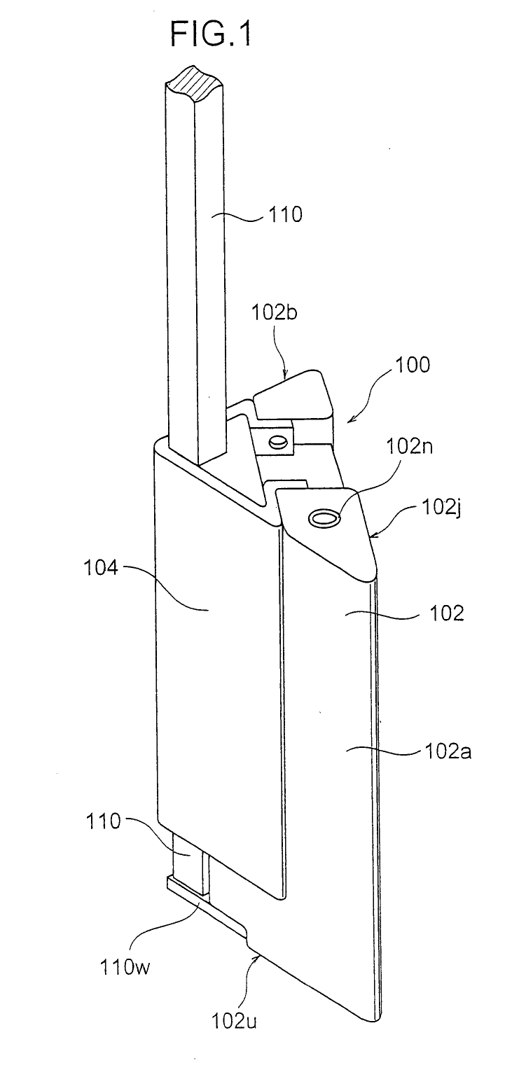

As shown in FIG. 1, the pole support assembly 100 according to the first embodiment comprises a weight member 102 adapted to support a part of an outer peripheral side surface of a pole 111 for a structure, for example, a tent having an upper structural member, such as canopy (not shown), and a retaining member adapted to be fastened to the weight member 102 so as to retain the pole 110 relative to the weight member 102. Generally, a structure, such as a tent, is provided with a plurality of poles. For example, in a tent having a square or oblong shape in top plan view, a pole is disposed at each of four corners of the tent. The pole 110 illustrated in FIG. 1 has a square shape in horizontal section.

Structure of Weight Member

As shown in FIG. 2, the weight member 102 has a first side surface 102a extending vertically, a second side surface 102b extending vertically and intersecting with the first side surface 102a, a third side surface 102j extending vertically and intersecting with the first side surface 102a and the second side surface 102b, and a guide recess 102d extending vertically along an intersect line 102c between the first and second side surfaces 102a, 102b to guide the part of the outer peripheral side surface of the pole 110. Preferably, the first and second side surfaces 102a, 102b are formed to intersect with one another at a right angle. When a pole 110 to be guided has a square shape in horizontal section, the guide recess 102d is formed to have a first side wall 102e and a second side wall 102f intersecting with one another at a right angle to define a bottom of the guide recess 102d. Preferably, the first side surface 102a and the first side wall 102e are formed to intersect with one another at a right angle. Preferably, the second side surface 102b and the second side wall 102f are formed to intersect with one another at a right angle. Preferably, a horizontal-sectional shape of the guide recess 102d is determined in conformity to a horizontal-sectional shape of the pole 110.

The third side surface 102j is disposed on the opposite side of the guide recess 102d. That is, the weight member 102 is formed to have an isosceles-right-triangular shape in horizontal section, in which a bottom edge, one edge extending from one end of the bottom edge to an apex and another edge extending from the other end of the bottom edge to the apex are defined, respectively, by the third side surface 102j, the first side surface 102a and the second side surface 102d.

A portion of the first side surface 102a adjacent to the guide recess 102d is formed as a first receiving surface 102g located parallel to the first side surface 102a and adapted to receive one of two inner surfaces of the retaining member 104. In this same manner, a portion of the second side surface 102b adjacent to the guide recess 102d is formed as a second receiving surface 102h located parallel to the second side surface 102b and adapted to receive the other inner surface of the retaining member 104.

That is, in the pole support member 100 according to the first embodiment, the weight member 102 is designed to have an outer peripheral side surface at least partially extending vertically (i.e. the first and second side surfaces 102a, 102b), and the guide recess 12d formed to continue from the vertically-extending outer peripheral side surface and extend vertically and adapted to guide the part of the outer peripheral side surface of the pole.

The weight member 102 further includes a container segment 102m for containing a liquid substance and/or a solid substance. The weight member 102 has a top surface 102n formed with an opening 102p for supplying the liquid substance and/or the solid substance into the container segment 102m therethrough. The opening 102p of the weight member 102 is designed to allow a cap, such as a screwed type or a push-in type (not shown), to be attached thereto. For example, the substance to be contained in the container segment 102m includes water, sand, aggregate, gravel, pebble and iron scrap. The substance contained in the container segment 102m can also be discharged therefrom through the opening 102p. Alternatively, a discharge port may be formed, but not shown, in the weight member 102 separately from the opening 102p.

The weight member 102 is made, for example, of plastic. Alternatively, the weight member 102 may be made of concrete, or metal, such as cast iron or lead, without providing the container segment 102m to the weight member 102.

The weight member 102 is also formed with a first receiving portion 102s and a second receiving portion 102t adapted to receive therein a part of the retaining member 104 so as to allow the retaining member 104 to be fastened to the weight member 102. For example, each of the first and second receiving portions 102s, 102t may be a groove formed in the weight member 102 in conformity to the shape and thickness of the retaining member 104. Further, the weight member 102 is formed with a first pin hole 105g adapted to receive therein a set pin for securing the retaining member 104 to the weight member 102. The weight member 102 is also formed with a second pin hole 105h adapted to receive therein another set pin for securing the retaining member 104 to the weight member 102. If a set screw is used in place of the set pin, a first screw hole and a second screw hole may be formed in the weight member 102.

The weight member 102 has a bottom surface 102u formed with a foot-receiving portion 102w at a position adjacent to the guide recess 102d. The foot-receiving portion 102w is designed to receive therein a foot portion 110w (see FIG. 1) located at a lower end of the pole 110.

In the pole support assembly 100 according to the first embodiment, the weight member 102 is formed to have an isosceles-right-triangular shape with an apex angle of 90-degree, in horizontal section. This shape can minimize redundant storage space, because it makes it possible to substantially eliminate the risk of occurrence of a dead space when a plural number of the pole support assemblies 100 are stored in a stacked manner. Further, in the pole support assembly 100 according to the first embodiment, the weight member 102 may be prepared using only a single die (mold).

While the weight member 102 in FIG. 2 is formed in the horizontal-sectional shape which has the same area in the vertical direction, the weight member 102 may be formed in a horizontal-sectional shape which has an area gradually reduced in a vertical direction from the bottom surface 102u to the top surface 102n, as indicated by one-dot chain line in FIG. 2.

Structure of Retaining Member

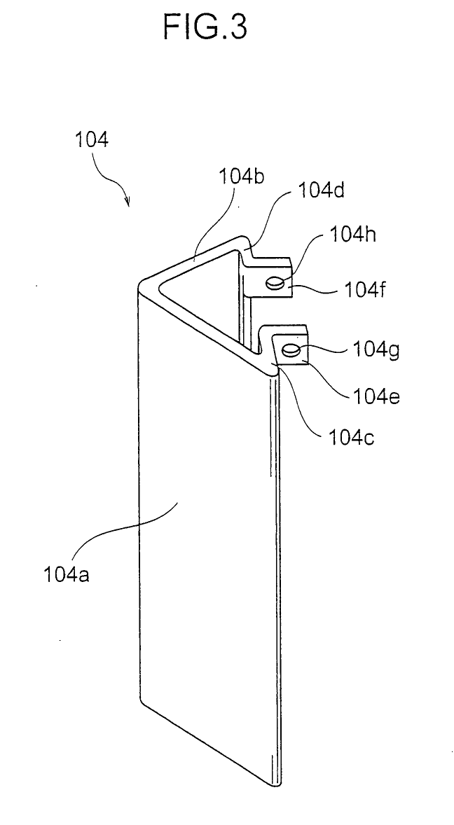

As shown in FIG. 3, the retaining member 104 has a first side plate portion 104a extending vertically, a second side plate portion 104b extending vertically and intersecting with the first side plate portion 104a, a first attaching portion 104c formed to continue from the first side plate portion 104a, a second attaching portion 104d formed to continue from the second side plate portion 104b, a first anchor portion 104e formed to continue from the first attaching portion 104c and a second anchor portion 104f formed to continue from the second attaching portion 104d. The retaining member 104 may be formed, for example, by subjecting a metal plate, such as a stainless-steel plate, to a bending process.

The first anchor portion 104e is formed with a first through-hole 104g adapted to allow the set pin or set screw for securing the retaining member 104 to the weight member 102 to be inserted thereinto. In the same manner, the second anchor portion 104f is formed with a second through-hole 104h adapted to allow the set pin or set screw for securing the retaining member 104 to the weight member 102 to be inserted thereinto. Preferably, a position and size/shape of the first through-hole 104g of the retaining member 104 is determined in conformity to those of the first pin hole 105g of the weight member 102. Further, a position and size/shape of the second through-hole 104h of the retaining member 104 is preferably determined in conformity to those of the second pin hole 105h of the weight member 102.

A portion of an inner surface of the first side plate portion 104a and a portion of an inner surface of the second side plate portion 104b serve as a guide portion for guiding a part of the outer peripheral side surface of the pole 10. Preferably, when the pole 110 to be guided has a square shape in horizontal section, respective inner surfaces of the first and second side plate portions 104a, 104b are formed to intersect with one another at a right angle. Preferably, the inner surfaces of the first and second side plate portions 104a, 104b has a contour determined in conformity to a horizontal-sectional shape of the outer peripheral side surface of the pole 110. Specifically, if the pole 110 to be guided has a square shape in horizontal section, the first and second side plate portions 104a, 104b of the retaining member 104 may be formed into an isosceles-right-triangular shape having an apex angle of 90-degree in top plan view.

Usage Mode of Pole Support Assembly

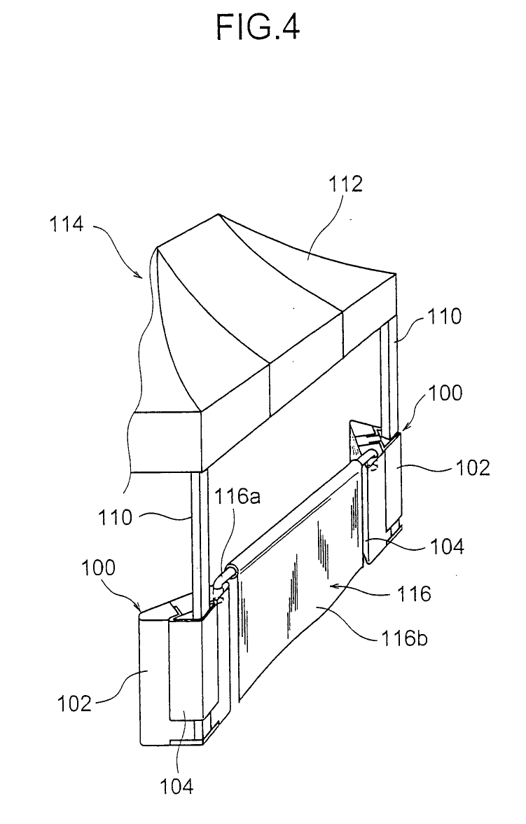

As shown in FIG. 4, a tent 114 having an oblong shape in a horizontal section comprises a canopy 112, and four poles 110. FIG. 4 illustrates only two of the poles 110 for the purpose of simplification of illustration. Firstly, a user supplies water into the weight member 102 from the opening 102p thereof, and attaches the cap (not shown) to the opening 102p. Then, the user sets up the weight member 102 in such a manner as to allow the guide recess 102d of the weight member 102 to come into contact with an outer peripheral side surface of the pole 110. Then, the user moves the retaining member 104 downward from above the weight member 102 along the weight member 102. More specifically, the user sets the retaining member 104 at a position where the two inner surfaces of the retaining member 104 can come into contact, respectively, with the first receiving surface 102g and the second receiving surface 102s of the weight member 102. Then, the user moves the retaining member 104 downward to insert the first attaching portion 104c and the second attaching portion 104d of the retaining member 104, respectively, into the first receiving portion 102s and the second receiving portion 102t of the weight member 102. A state after completion of the above operation is shown in to FIG. 1. Then, the user inserts a set pin or a set screw (not shown) into the first through-hole 104g of the retaining member 104 to fasten the set pin (or set screw) to the first pin hole (or screw hole) 105 of the weight member 102. In the same manner, four of the pole support assemblies 100 each comprising the weight member 102 and the retaining member 104 are set up, respectively, to the four poles 110. The pole support assembly 100 according to the first embodiment has a shape capable of fully surrounding the outer peripheral side surface of a lower portion of the pole 110. Thus, each of the poles 110 can be supported with significantly high stability.

In an operation for detaching the pole support assembly 100 from the pole 110, the user may detach the retaining member by detaching the set pin or screw and then sliding the retaining member 104 upward relative to the weight member 102. Thus, the operation for detaching the pole support assembly 100 according to the first embodiment from the pole 110 has no need for a particular tool. Thus, the pole support assembly 100 can be readily attached and detached.

If needed, the user may mount a half side curtain unit 116 between the adjacent two pole support assemblies 110. The half side curtain unit 116 comprises a side-curtain bar 116a and a side curtain 116b. The user mounts one end of the side-curtain bar 116a onto one of the pole support assembly 100, and mounts the other end of the side-curtain bar 116a to the other adjacent pole support assembly 100. The half side curtain unit 116 mounted onto the pole support assemblies 100 can separate an inner space of the tent 114 from the outside. That is, the half side curtain unit 116 can serve as a partition. Further, the half side curtain unit 116 mounted to the pole support assemblies 100 can conceal the inner space of the tent 114. Furthermore, a commercial message or advertisement may be printed on the side curtain unit 116, or a poster may be attached onto the side curtain unit 116. That is, the side curtain unit 116 may be used as an advertising medium. In addition, the half side curtain unit 116 mounted to the pole support assemblies 100 can effectively prevent wind, rainwater, sunshine or dusts from getting into the inner space of the tent 114.

In this usage mode of the pole support assembly 100 according to the first embodiment, an amount of protrusion from the tent 114 is significantly reduced as compared with the conventional pole supports. Thus, the side curtain unit 116 can be mounted between the pole support assemblies 100 without deformation of an original contour thereof. Specifically, in this usage mode of the pole support assembly 100 according to the first embodiment, the amount of protrusion from the tent 114 is only a thickness of the retaining member 104. This makes it possible to prevent occurrence of excessive “bulge” and “wrinkle” in the side curtain unit 116 so as to maintain excellent appearance. Thus, in this usage mode of the pole support assembly 100 according to the first embodiment, a silhouette of the side curtain attached thereto can be maintained substantially horizontally. Further, in this usage mode of the pole support assembly 100 according to the first embodiment, there is no protrusion toward the inner space of the tent 114. This makes it possible to prevent the user from stumbling over the pole support assembly 100. Furthermore, the pole support assembly 100 according to the first embodiment makes it possible to maximize a utilization rate of an internal area of the tent 114, and minimize a load of transportation of the pole support assembly 100 and a storage space.

In another usage mode, a plural number of the pole support assemblies 100 according to the first embodiment may be attached to one of the poles 110 in a superimposed manner. Thus, a number of the pole support assemblies 100 can be changed depending on use conditions of the tent 114, such as locational conditions, so as to ensure safety of the user and associated operators and facilitate setting up the tent with higher efficiency.

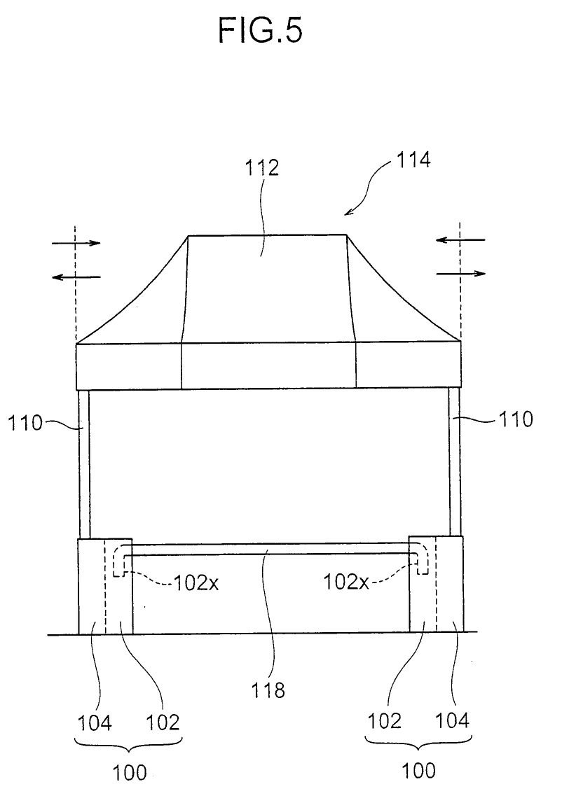

As shown in FIG. 5, a tent 114 having an oblong shape in a horizontal section comprises a canopy 112, and four poles 110. FIG. 5 illustrates only two of the poles 110 for the purpose of simplification of illustration. Each of the poles 110 is supported by the pole support assembly 100 comprising the weight member 102 and the retaining member 104. In this usage mode, the weight member 102 additionally has an arm-mounting portion adapted to allow a connection arm 118 for connecting two of the adjacent weight members 102 together to be mounted thereto. For example, the arm-mounting portion consists of a circular hole 102x for receiving therein an end of the connection arm 118

Preferably, the connection arm 118 is made of plastic, or metal, such as iron. Preferably, the connection arm 118 is formed in a round bar-shape. Each of opposite ends of the connection arm 118 is bent at a right angle. One of the ends of the connection arm 118 is fitted into the end-receiving circular hole of the first weight member 102 (weight member 102 on the left side in FIG. 5), and the other end of the connection arm 118 is fitted into the end-receiving circular hole of the second weight member 102 (weight member 102 on the right side in FIG. 5). The connection arm 118 serves as a reinforcing member for supporting a plurality of poles. The connection arm 118 can be used for preventing a lateral wobbling of the tent 114.

Modifications of Pole Support Assembly

(1-5-1) Pole Support Assembly for Sectionally Square-Shaped Pole

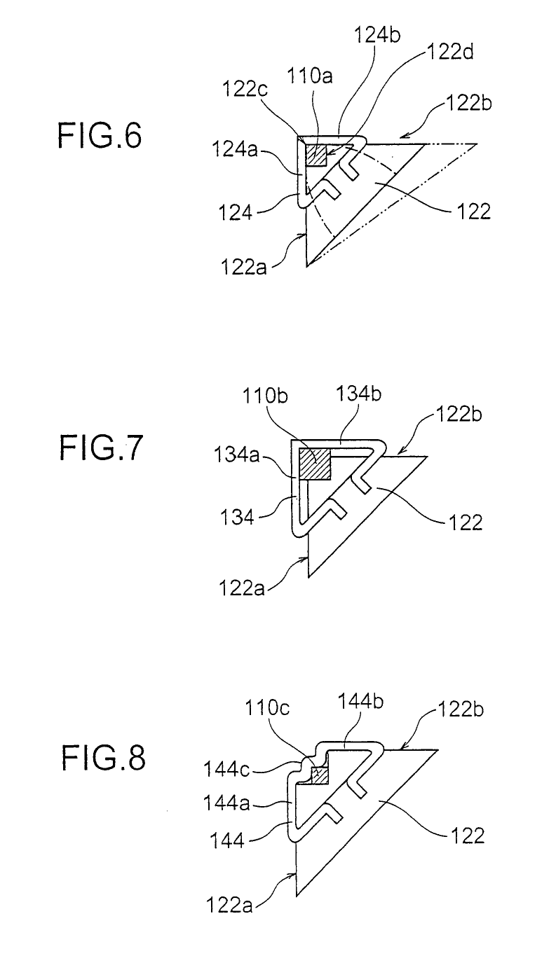

As shown in FIG. 6, for example in a quadrangular-shaped tent, when it is necessary to support a pole 110a having a square shape in horizontal section, a weight member 122 is formed to have a first side surface 122a extending vertically, a second side surface 122b extending vertically and intersecting with the first side surface 122a, and a guide recess 122d extending vertically along an intersect line 122c between the first and second side surfaces 122a, 122b to guide a part of an outer peripheral side surface of the pole 110a. The first and second side surfaces 122a, 122b are formed to intersect with one another at a right angle. One of four side surfaces of the pole 110a is disposed to be flush with the first side surface 122a. One of the remaining side surfaces of the pole 110a is disposed to be flush with the second side surface 122b.

While the weight member 122 in FIG. 6 has an isosceles-right-triangular shape in horizontal section, it may be formed to have a non-isosceles right-triangular shape in horizontal section, as indicated by the two-dot chain line in FIG. 6.

Further, while the first side surface 122a in FIG. 6 has a flat shape, it may be formed to have a curved shape, as indicated by the one-dot chain line in FIG. 6. While the second side surface 122b in FIG. 6 has a flat shape, it may be formed to have a curved shape, as indicated by the one-dot chain line in FIG. 6.

A retaining member 124 is fixed to the weight member 122. The retaining member 124 is formed to have a first side plate portion 124a extending vertically, and a second side plate portion 124b extending vertically and intersecting with the first side plate portion 124a. An inner surface of the first side plate portion 124a of the retaining member 124 is disposed to be flush with the first side surface 122a. An inner surface of the second side plate portion 124b of the retaining member 124 is disposed to be flush with the second side surface 122b. According to this pole support assembly, an amount of protrusion from the tent is only a thickness of the retaining member 124. This makes it possible to prevent occurrence of excessive “bulge” and “wrinkle” in a side curtain unit so as to maintain excellent appearance.

(1-5-2) Pole Support Assembly for Sectionally Square-Shaped Thick Pole

As shown in FIG. 7, for example in a quadrangular-shaped tent, when it is necessary to support a pole 110b having a square shape in horizontal section and a sectional area greater than that of the pole 10a in FIG. 6, the weight member 122 may be used. One of four side surfaces of the pole 110b is disposed outward relative to the first side surface 122a. One of the remaining side surfaces of the pole 110b is disposed outward relative to the second side surface 122b.

A retaining member 134 is fixed to the weight member 122. The retaining member 134 is formed to have a first side plate portion 134a extending vertically, and a second side plate portion 134b extending vertically and intersecting with the first side plate portion 134a. An inner surface of the first side plate portion 134a of the retaining member 134 is disposed outward relative to the first side surface 122a. An inner surface of the second side plate portion 134b of the retaining member 134 is disposed outward relative to the second side surface 122b. According to this pole support assembly, the pole 110b having a horizontal-sectional area greater than that of the guide recess 122d can be supported by using the same weight member 122 and changing only the retaining member.

(1-5-3) Pole Support Assembly for Sectionally Square-Shaped Thin Pole

As shown in FIG. 8, for example in a quadrangular-shaped tent, when it is necessary to support a pole 110c having a square shape in horizontal section and a sectional area less than that of the pole 110a in FIG. 6, the weight member 122 may be used. One of four side surfaces of the pole 110c is disposed inward relative to the first side surface 122a. One of the remaining side surfaces of the pole 110c is disposed inward relative to the second side surface 122b.

A retaining member 144 is fixed to the weight member 122. The retaining member 144 is formed to have a first side plate portion 144a extending vertically, a second side plate portion 144b extending vertically and located at a right angle with the first side plate portion 144a, and a pole support portion 144c formed to continue from the first and second side plate portions 144a, 144b and adapted to support the pole. An inner surface of the first side plate portion 144a of the retaining member 144 is disposed to be flush with the first side surface 122a. An inner surface of the second side plate portion 144b of the retaining member 144 is disposed to be flush with the second side surface 122b.

According to this pole support assembly, an amount of protrusion from the tent is only a thickness of the retaining member 144. This makes it possible to prevent occurrence of excessive “bulge” and “wrinkle” in a side curtain unit so as to maintain excellent appearance. Further, the pole 110c having a horizontal-sectional area less than that of the guide recess 122d can be supported by using the same weight member 122 and changing only the retaining member.

(1-5-4) Pole Support Assembly for Sectionally Circular-Shaped Pole

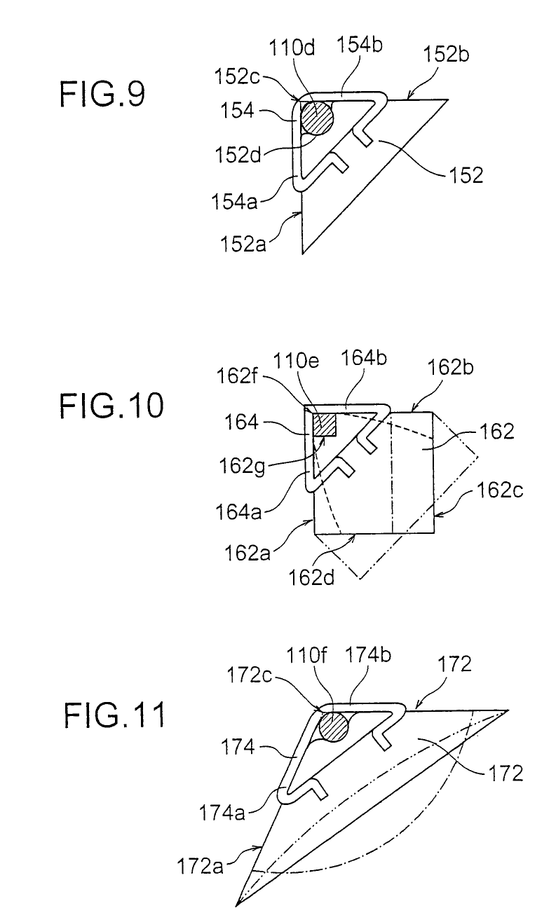

As shown in FIG. 9, for example in a quadrangular-shaped tent, when it is necessary to support a pole 110d having a circular shape in horizontal section, a weight member 152 is formed to have a first side surface 152a extending vertically, a second side surface 152b extending vertically and intersecting with the first side surface 152a, and a guide recess 152d extending vertically along an intersect line 152c between the first and second side surfaces 152a, 152b to guide a part of an outer peripheral side surface of the pole 110d. The first and second side surfaces 152a, 152b are formed to intersect with one another at a right angle. The guide recess 152d is formed to have a horizontal-sectional shape conformable to that of the pole 110d. Preferably, the horizontal-sectional shape of the guide recess 152d is formed to include a part of a circle having a radius equal to that of the horizontal-sectional shape of the pole 110d. Alternatively, the horizontal-sectional shape of the guide recess 152d may be formed to include a part of two adjacent edges of a square or polygon circumscribing a circle of the horizontal-sectional shape of the pole 10d.

A retaining member 154 is fixed to the weight member 152. The retaining member 154 is formed to have a first side plate portion 154a extending vertically, and a second side plate portion 154b extending vertically and intersecting with the first side plate portion 154a. Preferably, respective inner surfaces of the first and second side plate portion 154a, 154b of the retaining member 154 intersect with one another to form an intersecting portion having an arc shape conforming to the circle of the horizontal-sectional shape of the pole 110d. According to this pole support assembly, an amount of protrusion from the tent is only a thickness of the retaining member 154. This makes it possible to prevent occurrence of excessive “bulge” and “wrinkle” in a side curtain unit so as to maintain excellent appearance. Further, the arc-shaped portion of the retaining member 154 is brought into close contact with the outer peripheral side surface of the pole 110d. Thus, the pole 110b can be reliably supported.

(1-5-5) Sectionally Quadrangular-Shaped Pole Support Assembly

As shown in FIG. 10, for example in a quadrangular-shaped tent, when it is necessary to support a pole 110e having a square shape in horizontal section, a weight member 162 is formed to have first to fourth side surfaces 162a to 162d each extending vertically, and a guide recess 162d extending vertically along an intersect line 162f between the first and second side surfaces 162a, 162b to guide a part of an outer peripheral side surface of the pole 110e. The first and second side surfaces 162a, 162b are formed to intersect with one another at a right angle. The second and third side surfaces 162b, 162c are formed to intersect with one another at a right angle. The third and fourth side surfaces 162c, 162d are formed to intersect with one another at a right angle. That is, it is preferable that the weight member 162 has a square shape in horizontal section. Alternatively, the weight member 162 may be formed to have an oblong shape in horizontal section, as indicated by the one-dot chain line in FIG. 10. One of four side surfaces of the pole 110e is disposed to be flush with the first side surface 162a. One of the remaining side surfaces of the pole 110e is disposed to be flush with the second side surface 162b.

While the weight member 162 in FIG. 10 has in a square shape in horizontal section, it may be formed in a pentagonal shape (indicated by the two-dot chain line in FIG. 10) or any other polygonal shape or a polygonal tubular shape partially having a curved surface. In either case, it is particularly preferable that the horizontal-sectional shape of the weight member 162 falls within the range of a horizontal-sectional region of the tent. While the first side surface 162a in FIG. 10 has a flat shape, it may be formed to have a curved shape (indicated by the broken line in FIG. 10). Further, while the second side surface 162b in FIG. 10 has a flat shape, it may be formed to have a curved shape (indicated by the broken line in FIG. 10).

A retaining member 164 is fixed to the weight member 162. The retaining member 164 is formed to have a first side plate portion 164a extending vertically, and a second side plate portion 164b extending vertically and intersecting with the first side plate portion 164a. An inner surface of the first side plate portion 164a of the retaining member 164 is disposed to be flush with the first side surface 162a. An inner surface of the second side plate portion 164b of the retaining member 164 is disposed to be flush with the second side surface 162b. According to this pole support assembly, an amount of protrusion from the tent is only a thickness of the retaining member 164. This makes it possible to prevent occurrence of excessive “bulge” and “wrinkle” in a side curtain unit so as to maintain excellent appearance. Further, a large volume of water can be contained in a container segment (not shown) of the weight member 162 to reliably support the pole 110e.

(1-5-6) Sectionally Obtuse-Triangular-Shaped Pole Support Assembly

As shown in FIG. 11, for example in a hexagonal-shaped tent, when it is necessary to support a pole 110f having a circular shape in horizontal section, a weight member 172 is formed to have a first side surface 172a extending vertically, a second side surface 172b extending vertically and intersecting with the first side surface 172a, and a guide recess 172d extending vertically along an intersect line 172c between the first and second side surfaces 172a, 172b to guide a part of an outer peripheral side surface of the pole 110f. The first and second side surfaces 172a, 172b are formed to intersect with one another at an angle of 120-degree. That is, the weight member 172 has an obtuse-triangular shape in horizontal section. It is preferable that the weight member 172 has an obtuse-triangular shape in horizontal section. For example, when it is necessary to support the pole 110f having a circular shape in horizontal section, in a hexagonal-shaped tent, the weight member 172 is preferably formed in an obtuse-triangular shape having an apex angle of 120-degree, in horizontal section. Alternatively, when it is necessary to support the pole 110f having a circular shape in horizontal section, in a hexagonal-shaped tent, the weight member 172 is preferably formed in an obtuse-triangular shape having an apex angle of less than 120-degree, for example, in the range of 91 to 119-degree, in horizontal section. In either case, it is particularly preferable that the horizontal-sectional shape of the weight member 172 falls within the range of a horizontal-sectional region of the tent.

Alternatively, as indicated by one-dot chain line in FIG. 11, the weight member 172 may be formed in a sector shape in horizontal section. In this case, the canter of an arc of the sector shape may be located on the intersect line 172c or may be located outside the intersect point 172c or may be located inside the intersect point 172c.

Alternatively, as indicated by two-dot chain line in FIG. 11, the weight member 172 may be formed in a crescent shape (having two edges intersecting at an obtuse angle and an arc-shaped portion convexedly curved toward an intersect point between the edges), in horizontal section. One of four side surfaces of the pole 110f is disposed to be flush with the first side surface 172a. One of the remaining side surfaces of the pole 110f is disposed to be flush with the second side surface 172b.

A retaining member 174 is fixed to the weight member 172. The retaining member 174 is formed to have a first side plate portion 174a extending vertically, and a second side plate portion 174b extending vertically and intersecting with the first side plate portion 174a. Preferably, respective inner surfaces of the first and second side plate portion 174a, 174b of the retaining member 174 intersect with one another to form an intersecting portion having an arc shape conforming to a circle of a horizontal-sectional shape of the pole 110f. According to this pole support assembly, an amount of protrusion from the tent is only a thickness of the retaining member 174. This makes it possible to prevent occurrence of excessive “bulge” and “wrinkle” in a side curtain unit so as to maintain excellent appearance. In addition, a large volume of water can be contained in a container segment (not shown) of the weight member 162 to reliably support the pole 110f. Further, the arc-shaped portion of the retaining member 174 is brought into close contact with the outer peripheral side surface of the pole 110f. Thus, the pole 110f can be reliably supported. Furthermore, this pole support assembly makes it possible to maximize a utilization rate of an internal area of the tent.

(1-5-7) Sectionally Acute-Triangular-Shaped Pole Support Assembly

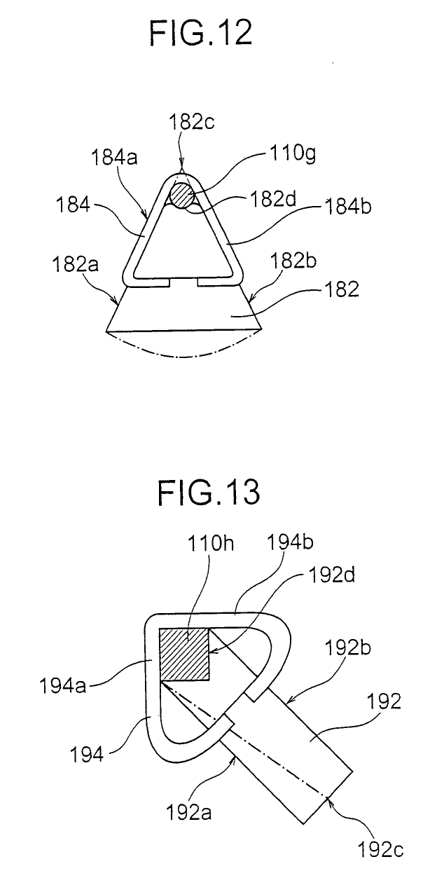

As shown in FIG. 12, for example in a triangular-shaped tent, when it is necessary to support a pole 110g having a circular shape in horizontal section, a weight member 182 is formed to have a first side surface 182a extending vertically, a second side surface 182b extending vertically and intersecting with the first side surface 182a, and a guide recess 182d extending vertically along an intersect line 182c between the first and second side surfaces 182a, 182b to guide a part of an outer peripheral side surface of the pole 110g. The first and second side surfaces 182a, 182b are formed to intersect with one another at an angle of 60-degree. That is, the weight member 182 has an acute-triangular shape in horizontal section. It is preferable that the weight member 182 has an acute-triangular shape in horizontal section. Alternatively, as indicated by one-dot chain line in FIG. 12, the weight member 182 may be formed in a sector shape in horizontal section.

A retaining member 184 is fixed to the weight member 182. The retaining member 184 is formed to have a first side plate portion 184a extending vertically, and a second side plate portion 184b extending vertically and intersecting with the first side plate portion 184a. Preferably, respective inner surfaces of the first and second side plate portion 184a, 184b of the retaining member 184 intersect with one another to form an intersecting portion having an arc shape conforming to a circle of a horizontal-sectional shape of the pole 110g. According to this pole support assembly, an amount of protrusion from the tent is only a thickness of the retaining member 184. This makes it possible to prevent occurrence of excessive “bulge” and “wrinkle” in a side curtain unit so as to maintain excellent appearance. Further, the arc-shaped portion of the retaining member 184 is brought into close contact with the outer peripheral side surface of the pole 110g. Thus, the pole 110f can be reliably supported. Furthermore, this pole support assembly makes it possible to maximize a utilization rate of an internal area of the tent.

(1-5-8) Sectionally Oblong-Shaped Pole Support Assembly for Sectionally Square-Shaped Pole

As shown in FIG. 13, for example in a quadrangular-shaped tent, when it is necessary to support a pole 110h having a square shape in horizontal section, a weight member 162 is formed to have a first side surface 192a extending vertically, a second side surface 192b extending vertically and in parallel relation to the first side surface 192a, a third side surface 192c intersecting with the first and second side surfaces 192a, 192b, and a guide recess 192d extending vertically on the opposite side of the third side surface 192c to guide a part of an outer peripheral side surface of the pole 110h. The guide recess 192d is formed in a portion connecting between the first and second side surfaces 192a, 192b. Two side surfaces of the pole 110h are supported by the guide recess 192d. As indicated by one-dot chain line in FIG. 13, the first and second side surfaces 192a, 192b may be formed to extend toward the guide recess 192d the at an angle of 90-degree with one another while gradually increasing a distance therebetween. In either case, it is particularly preferable that the horizontal-sectional shape of the weight member 192 falls within the range of a horizontal-sectional region of the tent.

A retaining member 194 is fixed to the weight member 192. The retaining member 194 is formed to have a first side plate portion 194a extending vertically, and a second side plate portion 194b extending vertically and intersecting with the first side plate portion 194a. Preferably, respective inner surfaces of the first and second side plate portion 194a, 194b of the retaining member 194 are formed to support the side surfaces of the pole 110h. According to this pole support assembly, an amount of protrusion from the tent is only a thickness of the retaining member 194. This makes it possible to prevent occurrence of excessive “bulge” and “wrinkle” in a side curtain unit so as to maintain excellent appearance.

Usage Mode of Pole Support Assembly for Plurality of Poles

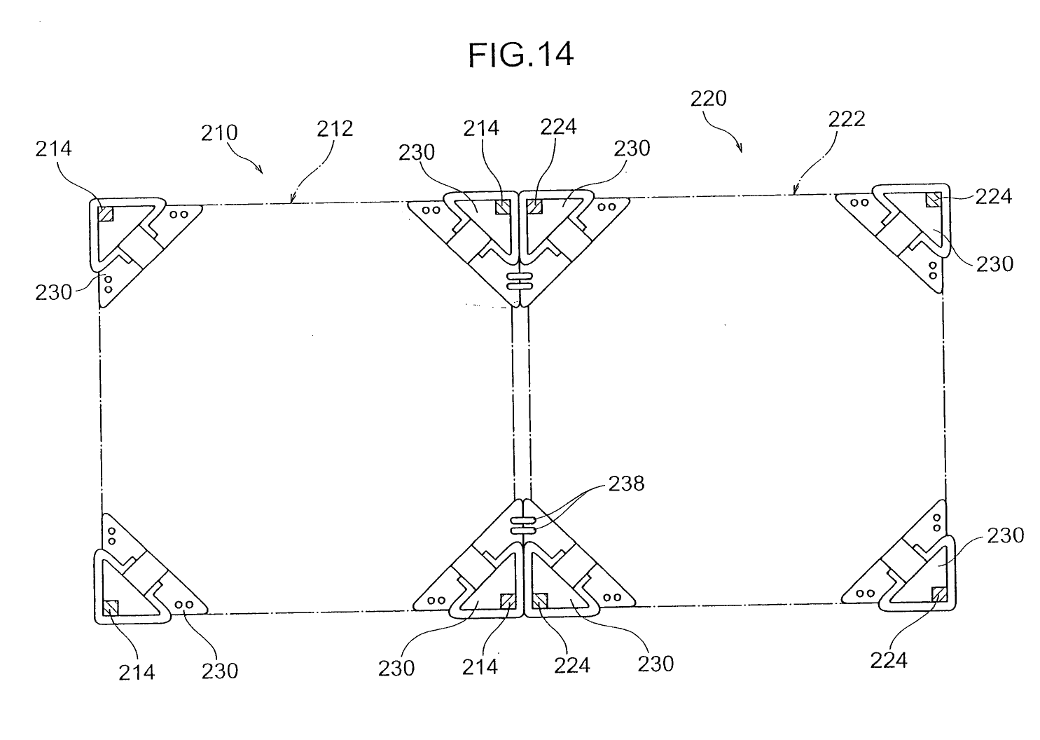

As shown in FIG. 14, first and second tents 210, 220 each having an oblong shape in horizontal section are disposed in a side-by-side arrangement. The first tent 210 comprises a first canopy 212 and four poles 214. The second tent 220 comprises a second canopy 222 and four poles 224. Each of the tents 214, 224 is supported by a pole support assembly 230. The pole support assemble 230 has the same structure as that of the aforementioned pole support assembly 100.

Each of two pairs of adjacent pole support assemblies 230 are connected to each other by a pair of connection members 238. A weight member of each of the pole support assemblies 230 includes a mounting portion adapted to receive therein an end of each of the connection members 238. For example, the mounting portion consists of a circular hole for receiving therein an end of each of the connection members 238. While the number of the connection members 238 in FIG. 4 is two, it may be one or three or more. This arrangement makes it possible to reliably support a plurality of tents, and prevent a lateral wobbling of the plurality of tents.

### [2] Second Embodiment

A pole support assembly according to a second embodiment of the present invention will be described below.

The following description will be made primarily about a difference between respective pole support assembly according to the first and second embodiments. The description about the pole support assembly according to the first embodiment will be fundamentally applied herein, particularly to structures, arrangements, functions, etc., omitted in the following description.

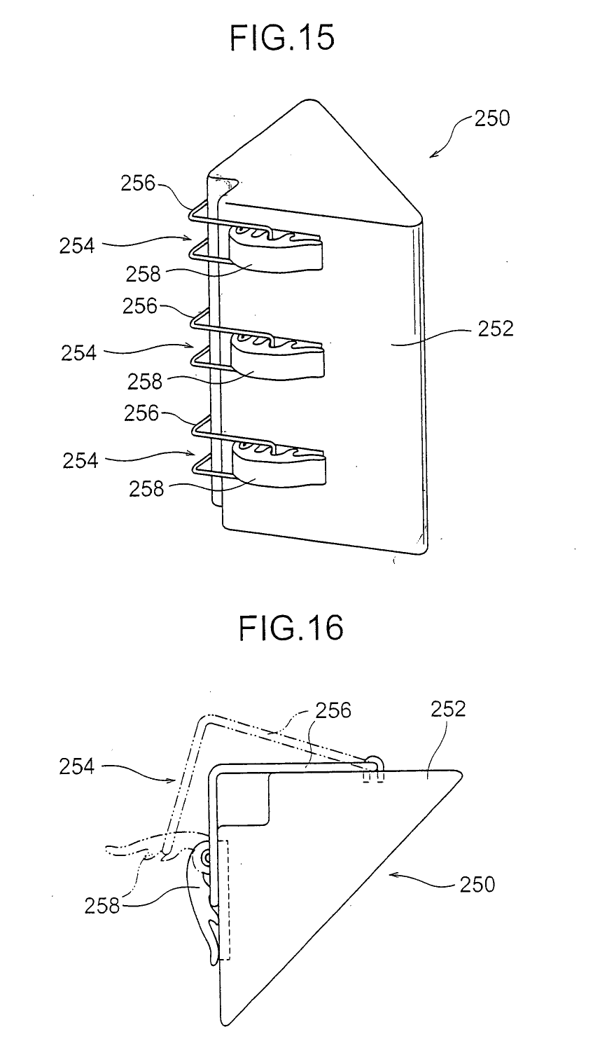

As shown in FIGS. 15 and 16, the pole support assembly 250 according to the second embodiment comprises a weight member 252 adapted to guide a part of an outer peripheral side surface of a pole (not shown) for a structure, such as a tent, and a lock-type retaining member 254 adapted to be fastened relative to the weight member 252 so as to retain the pole to the weight member 252. While the number of the rock-type retaining members 254 in FIG. 15 is three, it may be two, or may be four or more.

The lock-type retaining member 254 includes a first lock member 256 having one end fixed to one side surface of the weight member 252, and a second lock member 258 having one end fixed to another side surface of the weight member 252. The first lock member 256 is designed to be locked relative to the second lock member 25 so as to allow the pole to be tightly retained relative to the weight member 251. For example, the first lock member 256 may be composed of a wire rope having a base end fixed to the weight member 252 and a distal end formed in a U shape or C shape. For example, the second lock member 258 may have a base fixed to the weight member 252 and a buckle rotatably attached to the base. In this case, the buckle preferably includes a plurality of convex portions and a plurality of concave portions. The buckle is rotated upward relative to the base (indicated by two-dot chain line in FIG. 16), and the U-shaped wire rope of the first lock member 256 is hooked to the concave portion of the buckle. Then, the buckle is rotated downward to come into contact with the base. Through this operation, the first lock member 256 can be locked relative to the second lock member 258 (see FIG. 15). According to the pole support assembly 250 according to the second embodiment, an operation for attaching or detaching the pole support assembly 250 to or from the pole can be readily performed without the need for a particular tool. In addition, the plurality of concavo-convex portions formed in the buckle makes it possible to adjust an effective length of the U-shaped wire rope of the first lock member 256 so as to cope with various types of poles different in outer diameter.

### [3] Third Embodiment

A pole support assembly according to a third embodiment of the present invention will be described below.

The following description will be made primarily about a difference between respective pole support assembly according to the first and third embodiments. The description about the pole support assembly according to the first embodiment will be fundamentally applied herein, particularly to structures, arrangements, functions, etc., omitted in the following description.

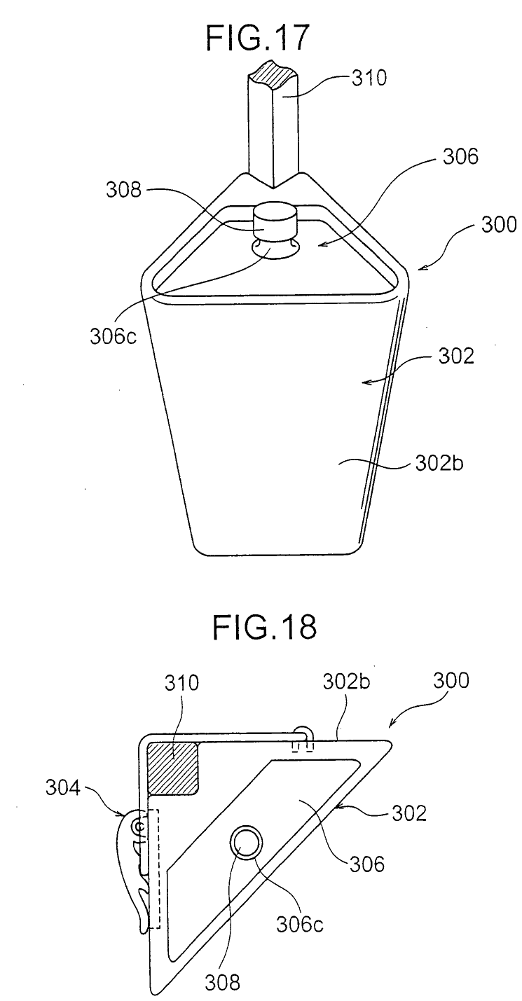

As shown in FIGS. 17 and 18, the pole support assembly 300 according to the third embodiment comprises a weight member 302 adapted to guide a part of an outer peripheral side surface of a pole 310 for a structure, such as a tent, and a lock-type retaining member 304 adapted to be fastened relative to the weight member 302 so as to retain the pole 310 to the weight member 302. The lock-type retaining member 304 has the same structure as that of the aforementioned lock-type retaining member 256.

The weight member 302 includes a body 302a and a container segment 306 detachably inserted into a body 302 in a nesting manner. The container segment 306 is composed of a hollow container having a top surface formed with an opening 306c. A cap 308 is attached to the opening 306c. The body 302b may also be formed with a discharge port (not shown) separately from the opening 306c. The container segment 306 can be detached from the body 302b to facilitate supplying water into the container segment 30. Further, the container segment 306 detachable from the body 302b makes it possible to facilitate transportation thereof.

### [4] Fourth Embodiment

A pole support assembly according to a fourth embodiment of the present invention will be described below.

The following description will be made primarily about a difference between respective pole support assembly according to the first and fourth embodiments. The description about the pole support assembly according to the first embodiment will be fundamentally applied herein, particularly to structures, arrangements, functions, etc., omitted in the following description.

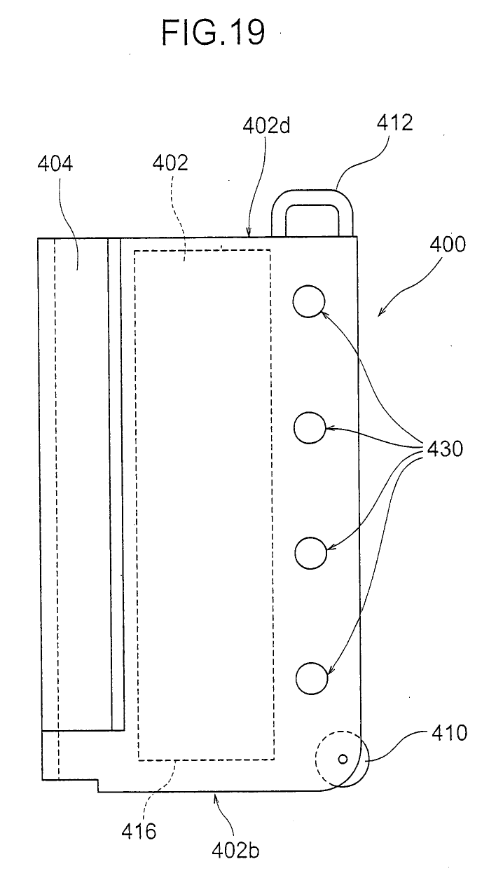

As shown in FIG. 19, the pole support assembly 400 according to the fourth embodiment comprises a weight member 402 adapted to guide a part of an outer peripheral side surface of a pole (not shown) for a structure, such as a tent, and a retaining member 404 adapted to be fastened relative to the weight member 402 so as to retain the pole to the weight member 402. The weight member 402 is also provided with a wheel 410 for moving the weight member 402, in the vicinity of a bottom surface 402b of the weight member 402. The wheel 401 is arranged at a position where the wheel 401 is not in contact with the ground when the weight member 402 is supported vertically or upstandingly, but brought into contact with the ground when the weight member 402 is inclined. Preferably, the wheel 410 is arranged at a position where the wheel 401 is not in contact with the ground when the weight member 402 is supported vertically, but brought into contact with the ground when the weight member 402 is inclined from the vertical position by 10-degree or more. Additionally, the weight member 402 is provided with a grip 412 for moving the weight member 402, in the vicinity of a top surface 402d of the weight member 402. According to the pole support assembly 400 according to the fourth embodiment, even after filing the container segment 416 with water, the weight member 40 can be readily transported.

Further, the weight member 402 is formed with one or more fastening holes 430 for fastening a string of a side curtain thereto. While the number of fastening holes in FIG. 19 is four, it may be one or may be two or more. The fastening hole 430 allows the string of the side curtain to be reliably fastened to the weight member 402.

### Fifth Embodiment

A pole support assembly according to a fifth embodiment of the present invention will be described below.

The following description will be made primarily about a difference between respective pole support assembly according to the first and fifth embodiments. The description about the pole support assembly according to the first embodiment will be fundamentally applied herein, particularly to structures, arrangements, functions, etc., omitted in the following description.

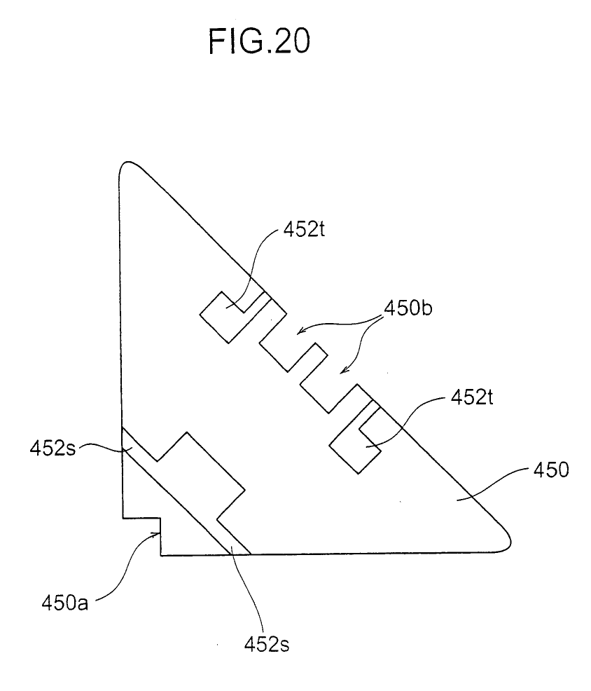

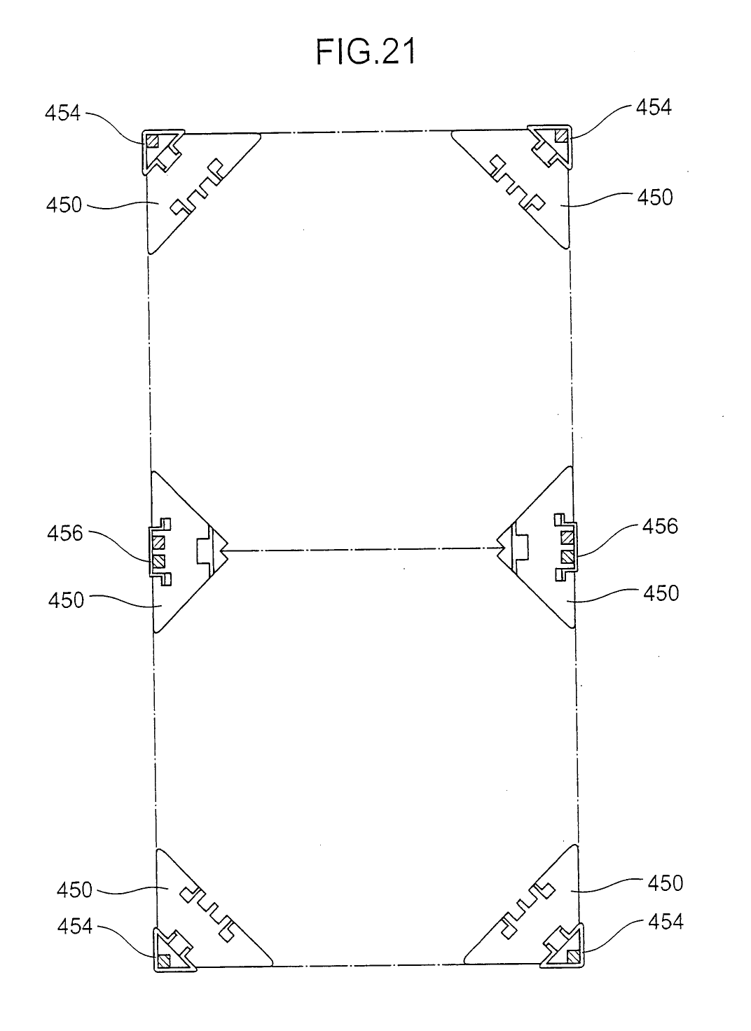

As shown in FIGS. 20 and 21, the pole support assembly according to the fifth embodiment comprises a weight member 450 which has a first pole guide portion 450a extending vertically to guide a part of an outer peripheral side surface of a first pole, and a second pole holding portion 450b extending vertically to partially hold respective outer peripheral side surface of a second pole and a third pole in adjacent relation to one another. The pole support assembly further includes a first retaining member 454 for supporting the first pole relative to the first pole guide portion 450a, and a second retaining member 456 for simultaneously supporting the second and third poles relative to the second pole holding portion 450b. The weight member 450 is formed with a first receiving portion 452s for receiving therein a part of the first retaining member 454 to allow the first retaining member 454 to be fixed to the weight member 450, and a second receiving portion 452t for receiving therein a part of the second retaining member 456 to allow the second retaining member 456 to be fixed to the weight member 450. According to the pole support assembly according to the fifth embodiment, two poles can be simultaneously supported while supporting another pole only by preparing one type of weight member 450.

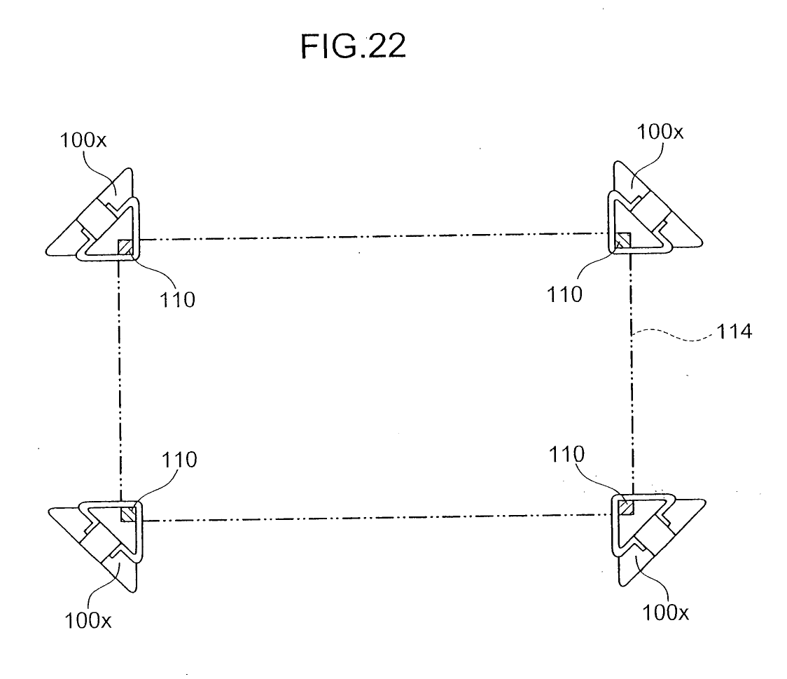

Instead of the usage mode as shown in FIG. 4, the pole support assemble according to each of the first to fifth embodiments can be turned over 180-degree relatively to a pole 110 horizontally from the position in the usage mode as shown in FIG. 4 so as to be set up at a position as indicated by. The pole support assemble 100X set up as shown in FIG. 22 allows an internal area of a tent 114 to have a utilization rate close to 100%. Thus, the pole support assembly of the present invention makes it possible to maximize a utilization rate of an internal area of the tent.

The pole support assemble of the present invention can reliably support a pole for a tent, and can be stored in a stacked manner.

Further, the pole support assemble of the present invention allows a side curtain to be attached thereto in a state after supporting a tent pole, while maintaining a silhouette of the side curtain substantially horizontally.

The pole support assemble of the present invention has a shape capable of minimizing redundant storage space and facilitating transportation.

Although the present invention has been described with reference to several preferred embodiments, these embodiments are not meant to be construed in a limiting sense. Various modifications and changes of the disclosed embodiments will become apparent to persons skilled in the art upon reference to the description of the invention, and these modifications and changes will be included in the scope of the present invention defined by appended claims.

What is claimed is:

1. A pole support assembly designed to support a pole for a tent having an upper structural member, comprising:
a weight member adapted to guide a part of an outer peripheral side surface of said pole, said weight member having a first side surface extending vertically, a second side surface extending vertically and intersecting with said first side surface, and a guide recess extending vertically along an intersect line between said first and second side surfaces to guide said part of the outer peripheral side surface of said pole; and
a retaining member adapted to be fastened to said weight member so as to retain said pole relative to said weight member, said retaining member includes including a first lock member having one end adapted to be fastened to said weight member, and a second lock member having one end adapted to be fastened to said weight member, and a second lock member having one end adapted to be fastened to said weight member, said first lock member being formed of a wire rope which has a base end fixed to said weight member and a distal end formed in a U shape or C shape, said second lock member including a base fixed to said weight member and a buckle rotatably attached to said base,
wherein said first lock member is designed to be locked relative to said second lock member so as to retain said pole relative to said weight member.

2. The pole support assembly as defined in claim 1, wherein said weight member is provided with a wheel for moving said weight member.

3. The pole support assembly as defined in claim 1, wherein said weight member is formed with at least one fastening hole each adapted to allow a string of a side curtain for said structure to be fastened thereto.

4. The pole support assembly as defined in claim 2, wherein said weight member is formed with at least one fastening hole each adapted to allow a string of a side curtain for said structure to be fastened thereto.
